(19) United States
(12) Patent Application Publication
(10) Pub. No.: US 2026/0085673 A1
(43) Pub. Date: Mar. 26, 2026

(54) CRYOGENIC TANDEM PUMP WITH ASYNCHRONOUS DRIVES, ZERO TANK RETURN

(71) Applicant: ACD, LLC, Santa Ana, CA (US)

(72) Inventors: Alexis LEFEVRE, Sausheim (FR); Patrick BOYLE, Costa Mesa, CA (US)

(21) Appl. No.: 19/338,935

(22) Filed: Sep. 24, 2025

Related U.S. Application Data
(60) Provisional application No. 63/698,489, filed on Sep. 24, 2024.

(51) Int. Cl. F04B 37/08; F04B 41/06; F04B 49/00; F04B 51/00; F17C 7/02

(52) U.S. Cl. CPC F04B 37/08; F04B 41/06; F04B 49/00; F04B 51/00; F17C 7/02; F17C 2221/012; F17C 2221/014; F17C 2221/017; F17C 2223/0161; F17C 2227/0142; F17C 2227/0178; F17C 2227/0185; F17C 2250/043; F17C 2250/0443; F17C 2250/0636

(57) ABSTRACT

There is disclosed a cryogenic tandem pump system comprising a cryogenic reservoir for storing cryogenic liquid, a first pump engaged with a first actuator and configured with a sump. The system further including a second pump engaged with a second actuator and is also configured with a sump. The reservoir, sumps and pumps are fluidly connected via piping and are configured with a pump controller. The pump controller is configured to dynamically control displacement, velocity and acceleration of the first and second pumps. The pump controller regulates the flow and pressure of cryogenic liquid between the first and second pumps to produce zero return to the reservoir.

### RELATED APPLICATION INFORMATION

This application claims priority to Provisional Application No. 63/698,489 filed Sep. 24, 2024, entitled “CRYOGENIC TANDEM PUMP WITH ASYNCHRONOUS DRIVES, ZERO TANK RETURN,” which is incorporated herein by reference in its entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to the storage, transmission and use of cryogenic liquids.

### Description of the Related Art

Cryogenic liquids are substances that remain in liquid form at extremely low temperatures, typically below −150° C. (−238° F.). Examples include liquid nitrogen, liquid helium, and liquid hydrogen. These liquids have a wide range of applications, such as refrigeration, medical treatments, scientific research, and even as alternative fuels.

Due to the unique properties of cryogenic liquids, storage, pumping, and utilization face unique challenges. In normal conditions, such as at room temperature, cryogenic liquids quickly evaporate thus requiring specially engineered containers with specialized pumping mechanisms. The types of pumps utilized in any given cryogenic system must also be taken into consideration. Each pump has a Net Positive Suction Head Required (NPSHr) to permit the cryogenic liquid to be transferred by the pump. This alone faces many challenges including heat inleak, cavitation, pump efficiency and overflow. Furthermore, in industrial settings, cryogenic pumping systems often take hundreds and in some instances thousands of cubic meters in space to house the container and pumping system making fueling applications difficult to achieve. Such systems are also costly, complex to maintain, and frequently lead to either excessive or insufficient retention of cryogenic liquid within the system.

Safety is also a critical consideration when handling cryogenic liquids, as they are frequently stored and transported under high pressure. Improperly designed or poorly maintained pumping systems or storage containers can pose significant hazards. For instance, standard practice often involves using return lines that feed excess cryogenic liquids from the pump back into the storage container which generate storage tank pressure buildup, which would have to be vented to atmosphere. While necessary for pressure control, this approach reduces efficiency, promotes vaporization of the cryogenic liquid, and requires additional piping and materials, which in turn increases the likelihood of system risks.

There currently exists a need for a cryogenic liquid pump system that pumps cryogenic liquid in a safe, energy efficient manner while limiting excessive overflow of cryogenic liquid that is often fed back into the system.

### THE DRAWINGS

FIG. 1 is a perspective view of a cryogenic tandem pump system.

FIG. 2 is a perspective view of a boost pump within the system.

FIG. 3 is a perspective view of a main pump within the system.

FIG. 4 is a cross-sectional view of the boost pump within the system.

FIG. 5 is a front view of a dual sump pump embodiment.

FIG. 6 is a schematic diagram of the cryogenic tandem pump system.

FIG. 7 is a flow chart of the cryogenic tandem pump system.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Transportation of cryogenic liquids includes a reservoir housing cryogenic liquid that is connected to a pump via piping that transports the cryogenic liquid to a final application, such as refrigeration of materials, medical treatments, scientific research, or as an alternative fuel. Most systems utilize positive displacement (PD) pumps for handling medium and high-pressure cryogenic liquids, as they move a fixed volume of cryogenic liquid per pump cycle, making them ideal for pressurization, precise dosing, fueling, and tank transfers. In cryogenic pumping systems, maintaining sufficient NPSH is critical to prevent cavitation and temperature variance in the highly volatile cryogenic liquid. Cavitation refers to the damaging formation and collapse of vapor bubbles.

PD pumps have a minimum NPSH requirement (NPSHr) to operate and move liquids through connected piping. PD pumps by design trap a fixed volume of fluid, in this case cryogenic liquid, within a chamber and mechanically pass the fluid from the inlet side to a discharge side. Mechanically driven PD pumps include a piston, plunger or diaphragm that utilize a back-and-forth motion to move the fluid.

Often a second pump, typically called a booster pump, is placed upstream from the first PD pump to increase suction pressure, stabilize flow, and ensure available NPSH (NPSHa) remains above the minimum NPSHr threshold for the PD pump. The booster pump is often a centrifugal pump. A centrifugal pump includes impellers that rotate within a housing in effect trapping fluid within recesses to then push the fluid out through an outlet. However, the PD paired with a centrifugal pump causes issues.

When centrifugal booster pumps are paired with PD pumps, the centrifugal booster pumps are designed to deliver slightly higher flow rates to compensate mainly the PD pump pulsations, but also pressure losses, and the vaporization tendencies of cryogenic fluids, ensuring reliable, cavitation-free operation. A centrifugal pump produces a near constant flow whereas PD pumps produce a nearly sinusoidal flow (caused by the sinusoidal displacement of the crank that pushes the fluid out). The inconsistency in flow rates creates a buildup of pressure at the PD pump suction, which can damage the pump or require external devices to absorb these pulsations leading to heat inleak and increased cavitation risks. Typical cryogenic pumping systems incorporate an overflow line to release this pressure and feed excess cryogenic liquid back to a cryogenic storage container (often referred to as “tank return”). This process also increases the risk of heat inleak and generally loss of efficiency and even loss of costly cryogenic liquid.

### The System

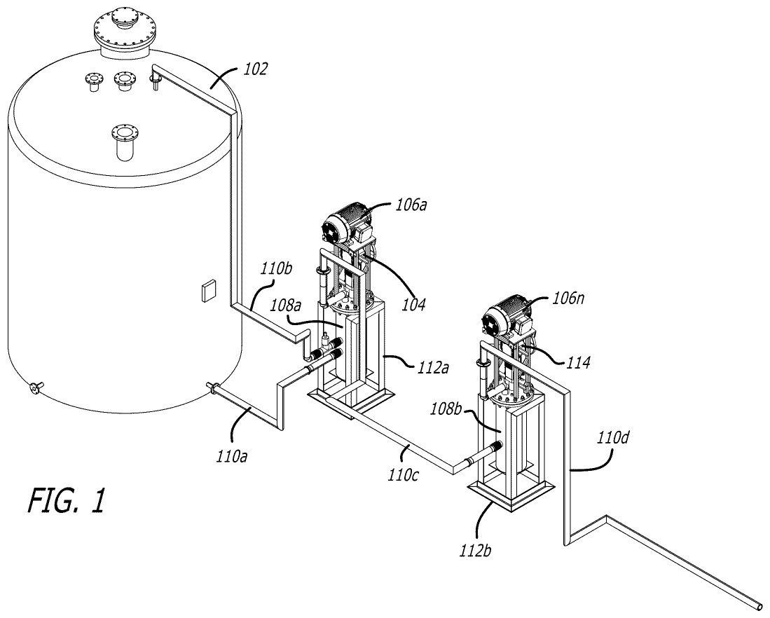

Referring now to FIG. 1, a cryogenic tandem pump system 100 producing zero tank return is described. The cryogenic tandem pump system 100 has a tank reservoir 102 fluidly connected to a boost pump 104, and a main pump 114.

The reservoir 102 houses cryogenic liquid such as liquid nitrogen, liquid helium, liquid hydrogen or any other liquid to be stored at extremely low temperatures, typically below −150° C. (−238° F.). The reservoir 102 has one or more access points for dispensing cryogenic liquid within the reservoir 102. For example, the reservoir 102 may have inlets for piping to dispense cryogenic liquid from an external source. The reservoir 102 may be formed in different shapes, although generally, a cylindrically shaped reservoir 102 is preferred. The reservoir 102 can store cryogenic liquids and may have a size of from as little as 500 liters upwards to 1,000,000 liters or more, depending on the applicable application of the cryogenic tandem pump system. The reservoir 102 may also be configured to actively refrigerate the cryogenic liquid such as with refrigerators or reliquefiers connected to the reservoir to maintain steady temperatures or manage boil-off.

The reservoir 102 is formed from specialized material, capable of withstanding the very low temperatures required by the cryogenic liquid—below −150° C. Such materials include stainless steel, aluminum alloys, nickel-based alloys, copper alloys or other similar materials capable of withstanding extremely low temperatures. Additionally, the reservoir 102 may also be insulated in that the exterior walls contain an insulative layer of material to help reduce heat loss. The exterior walls of the reservoir 102 insulative formation may be formed by a double wall, or multilayer superinsulation. For example, the reservoir 102 that is double-walled may permit a vacuum barrier wherein all the air between the two walls is removed providing a vacuum which serves as a better insulator than the air removed.

The reservoir 102 is fluidly connected to a boost pump 104 via piping 110a and 110b. The cryogenic tandem pump system 100 utilizes piping 110a and 110b to move the cryogenic liquid from the reservoir 102 to a sump 108a configured with a boost pump 104. The sump 108a and sump 108b act as a collection basin for the cryogenic liquid from which components of the pumps engage and disperse the cryogenic liquid. As will be discussed below, the boost pump 104 and a main pump 114 each are connected with sump 108a and sump 108b. The boost pump 104 draws in cryogenic liquid via piping 110a and 110b from the reservoir 102 into the sump 108a. The boost pump 104 then discharges the cryogenic liquid through piping 110c to the sump 108b connected to the main pump 114. From the sump 108b the main pump 114 discharges the cryogenic liquid through outlet piping 110d to the final application, such as refrigeration of materials, medical treatments, scientific research, or as an alternative fuel.

Piping 110a and 110b are configured to feed the cryogenic liquid into the sump 108a through gravity feed, The sumps 108a and 108b upon initial integration may be empty, and the boost pump 104 and main pump 114 may require priming to feed cryogenic liquid into the system. Commercially used methods of priming the boost pump 104 and main pump 114 such as venting and purging or any other method of priming pumps may be used to prime the boost pump 104 and main pump 114, and in effect fill the sumps 108a and 108b.

Piping 110a, 110b, 110c, and 110d may be configured with various bends and formations to fluidly connect the reservoir 102 to the sump 108a. For example, piping 110a and 110b may contain elbows to change the direction of flow, with 90-degree elbows, 45-degree elbows and long-radius bends. Piping 110a, 110b, 110c, and 110d may also integrate offsets that are created by using two angled fittings to shift piping laterally, or tee and wye junctions to permit branching into additional lines that lead into system. Other commercially used methods of pipe fittings may be used to connect the piping 110a, 110b, 110c, and 110d from the reservoir 102 to the end application such as cross fittings, reducers or expanders, expansion loops, bellows or other method for pipe fitting. Moreover, piping 110a, 110b, 110c, and 110d may also utilize a variety of valves to regulate or block flow, and accessories such as couplings and unions for joining sections, adapters for connecting different pipe types, caps or plugs to seal off ends, flanges, gate valves, globe valves, ball valves, butterfly valves, low-pressure lines, check valves, extended bonnets to separate seals from extremely cold temperatures. The various valves and accessories may be placed intermittently or in specified points along the piping 110a, 110b, 110c, and 110d and/or at the connection points in the system 100 from the reservoir 102 and end application of the cryogenic liquid.

The piping 110a, 110b, 110c, and 110d are also made from specialized material capable of withstanding the very low temperatures required by the cryogenic liquid, namely below −150° C. Such materials include stainless steel, aluminum alloys, nickel-based alloys, copper alloys or other similar materials capable of withstanding extremely low temperatures. Piping 110a, 110b, 110c, and 110d may also be insulated to reduce the risk of heat loss during transfer of the cryogenic liquid. Piping 110a, 110b, 110c, and 110d may utilize double wall vacuum insulation, insulated single wall piping, flexible cryogenic hoses or other methods to reduce heat loss of the cryogenic liquid.

In certain applications of the cryogenic tandem pump system 100, the reservoir 102 may be positioned at a height greater than the boost pump 104 to rely upon gravity entirely to move the cryogenic liquid. However, in other instances the cryogenic tandem pump system 100 can be utilized in narrower and more cramped spaces. For example, the cryogenic tandem pump system 100 may be applied to a shipping hauler wherein the cryogenic tandem pump system 100 is housed in the hull of the ship. By design, the hull of the ship is much narrower requiring intricate formation of the piping 110a, 110b, 110c, and 110d than in most industrial applications.

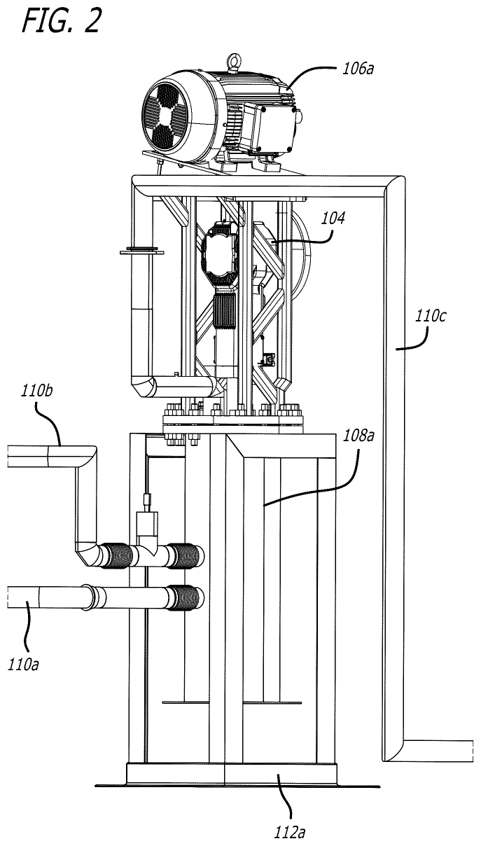

Referring now to FIG. 2, an exemplar of the boost pump 104 of the cryogenic tandem pump system 100 is shown. The piping 110a and 110b are connected to the sump 108a. The boost pump 104 is positioned onto a frame 112a that suspends the pump above the sump 108a. The frame 112a extends upwardly to support a actuator 106a positioned atop the boost pump 104. The actuator 108a may also be placed separately from the boost pump 104. For example, the boost pump 104 and the sump 108a may be stacked as shown but the actuator may be placed behind or below the frame 112a. The frame 112a may also have various configurations. As shown, the frame 112a is formed in rectangular fashion with hollowed sidewalls. In alternative embodiments, the frame 112a may be brackets on a wall or any other formation that suspends the boost pump 104 above the sump 108a. The frame 112a may be made from materials such as stainless steel, aluminum alloys, nickel-based alloys, copper alloys or other similar materials capable of supporting the boost pump 104 and sump 108a. The actuator 106a may be one of many types sufficient to drive the boost pump 104 such as electric, hydraulic, pneumatic or other forms of power. For instance, the actuator 106a may be an electric actuator. The actuator 106a may be the type commercially used. Extending from the upper portion of the sump 108a is piping 110c. Piping 110c carries the dispensed cryogenic fluid dispersed from the boost pump 104.

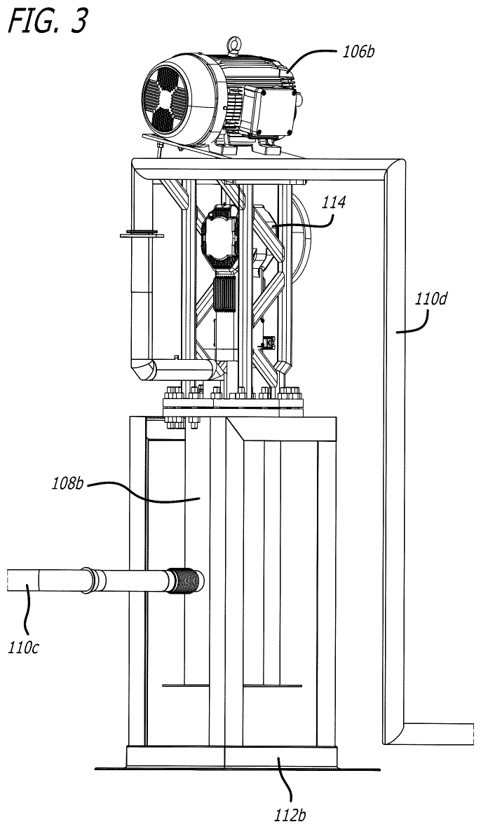

Referring now to FIG. 3, an exemplar of the main pump 114 is shown. Piping 110c is fluidly connected to the sump 108b. The main pump 114 is similarly positioned as the boost pump 104 atop a frame 112b. The frame 112b is the same as frame 112a discussed above. Additionally, the main pump 114 is connected with the sump 108b and a actuator 106b. The sump 108b and the actuator 106b are the same as the sump 108a and actuator 106a discussed above. Extending from the upper portion of the sump 108b is piping 110d. Piping 110c carries the dispensed cryogenic fluid dispersed from the main pump 114.

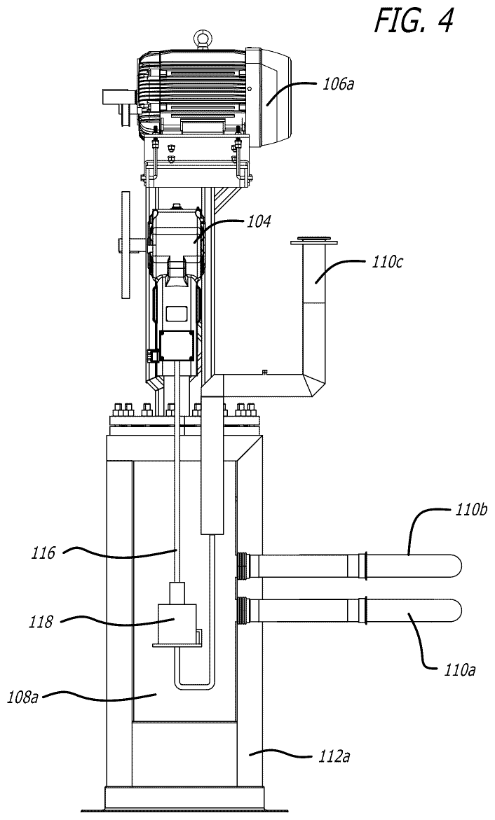

Referring now to FIG. 4, a cross sectional view of the boost pump 104 is shown. The main pump 114 and configured components are similarly situated to the boost pump 104 configuration. Although FIG. 4 makes reference to the boost pump 104, it is understood that the following discussion of the boost pump 104 is also applicable to the main pump 114. The boost pump 104 and the main pump 114 may be mono-cylinder or multiple cylinders for mechanically driving the cryogenic liquid from the sump 108a through outlet piping 110c. For example, a mono-cylinder PD pump has one piston 116 moving inside a cylindrical chamber 118 that drives fluid outward to an outlet piping 110c. The boost pump 104 and the main pump 114 may be a single or double acting pump. Single acting means that the liquid is pumped only on one side of the piston such that there is a suction stroke where the fluid is drawn into the cylindrical chamber, and discharge stroke where the fluid is pushed out from the cylindrical chamber. Double-acting means that liquid is pumped on both sides of the piston such that fluid is continually being suctioned and discharged with each stroke of the piston.

The boost pump 104 and the main pump 114 may be identical with each other or may vary in size, dimension, mono-or multi-cylinder, single or double acting. For example, the boost pump 104 may be multi-cylinder that is double acting whereas the main pump 114 may be mono-cylinder that is single acting. The piston 116 and cylindrical chamber 118 of the boost pump 104 and main pump 114 may also be variable in size. For example, the piston and cylindrical chamber may have larger dimensions in the boost pump 104 than the piston and cylindrical chamber 118 in the main pump 114. In this way, the boost pump 104 and the main pump 114 may have different NPSHr values and produce NPSHa.

The boost pump 104 and the main pump 114 may be fully submerged, externally placed or semi-submerged as shown in FIG. 1. When the boost pump 104 or the main pump 114 are fully submerged, the actuators 106a/b are placed entirely within the reservoir 102 such that they are submerged in the cryogenic liquid to eliminate the need for sumps 108a/108b. When the boost pump 104 and the main pump 114 are externally placed, only the active component of the pumps are placed within the liquid typically through a small vacuum jacketed cylinder. When the boost pump 104 and the main pump 114 are semi-submerged, the actuators 106a/106b are placed externally from the cryogenic liquid and the pumps are submerged within the liquid via the sumps 108a/108b. The sumps 108a/108b act as a small reservoir to house cryogenic liquid drawn in by either of the pumps during operation.

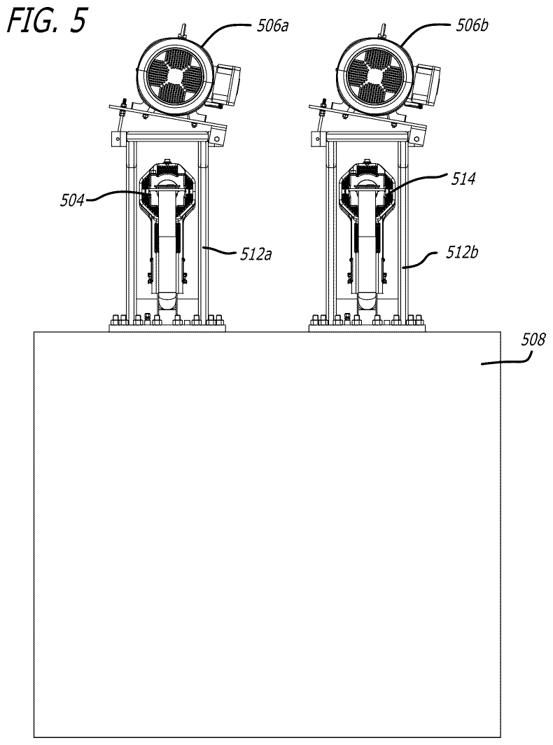

As shown in FIG. 5, in alternative embodiments, the system 110 may have a boost pump 504 and a main pump 514 that share a dual sump 508 configured with actuators 506a and 506b and a frame 512a and 512b respectively. The system 500 is the same as and shares features and functionality of similar components described in the embodiments of the system 100. In utilizing a dual sump 508 the overall footprint of the system 500 in that a boost pump 504 and a main pump 514 share a single dual sump 508 reducing the overall material required, the heat inleak, and space needed to house the two. The boost pump 504 utilizes fluidly connected piping (not shown) to fill the sump 508 with cryogenic liquid from a reservoir (not shown). The boost pump 504 in this embodiment may draw in cryogenic liquid from the reservoir into the sump 508 at the required NPSHr for the main pump 514. The main pump 514 then disperses available cryogenic liquid within the sump 508 to the final application, such as refrigeration of materials, medical treatments, scientific research, or as an alternative fuel, via piping (not shown).

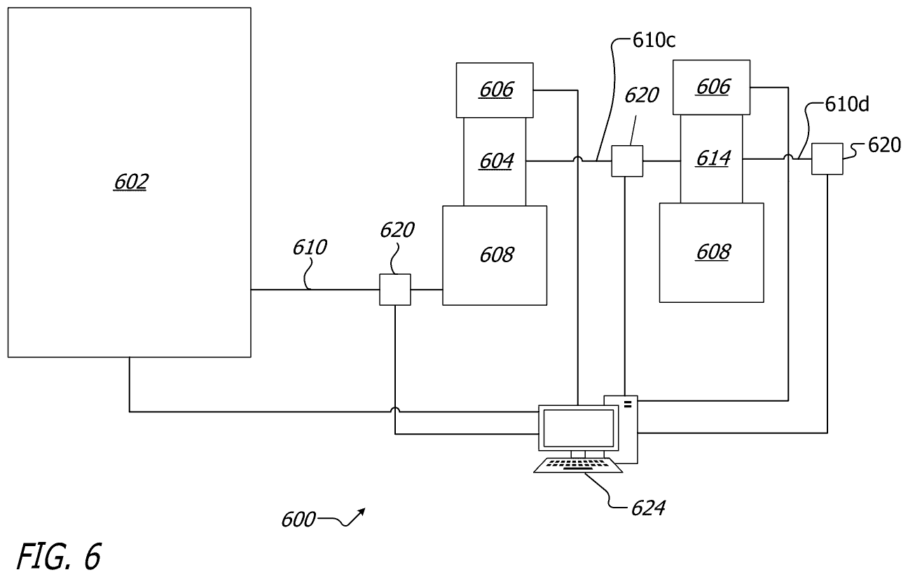

FIG. 6 is a schematic diagram of the cryogenic tandem pump system 600. The cryogenic tandem pump system 600 is the same as the cryogenic tandem pump system 100 discussed previously. The cryogenic tandem pump system 600 includes a reservoir 602, boost pump 604, main pump 614, actuators 606a/606b, sumps 608a/608b fluidly connected by piping 610a-d. The stated components are as described above regarding FIGS. 1-5. The cryogenic tandem pump system 600 additionally includes a number of gauges 620 dispersed throughout the cryogenic tandem pump system 600. The gauges 620 monitor for example the temperature, NPSHa, and flow of the cryogenic liquid within the system. It is to be understood that the gauges 620 may be positioned at any point in the cryogenic tandem pump system 600. For example, the gauges 620 may be configured within the piping 610 positioned both before and after the booster pump 606. The gauges 620 may be but are not limited to pressure gauges, level gauges, flow meters, temperature gauges, vacuum gauges or any other gauges capable of monitoring the flow of cryogenic fluid within the system. The gauges 620 may have an external display to permit an operator to view the readings taken in the system. The gauges 620 included in the cryogenic tandem pump system 600 must be properly calibrated to function correctly. For example, the temperature-sensitive gauge 620 such as a bimetallic strip, a thermocouple, a thermistor, or some other type of temperature-sensitive gauge must be put in contact with the cryogenic liquid that is being measured. The gauge 620 should be fully submerged in the liquid, if possible. In other instances, the gauge 620 may be coupled to and used to calculate the temperature of an alloy or metal of a component that is in contact with cryogenic liquid at liquid temperature in the system. The gauge 620 must stabilize before giving accurate readings. Additionally, the gauges 620 may also be connected to a controller 624.

The controller 624 may be a device or electronic system used to control the operation of devices, components or elements of the cryogenic tandem pump system 600. Controller 624 may be used to control a variety of different devices and components in the system 600, including the gauges 620, valves 622, the boost pump 604, the main pump 614 and the actuators 606a/606b. The controller 624 may include one or more of each of programmable logic controllers (PLCs), microcontrollers, and computer-based controllers. Programmable logic controllers (PLCs) are specialized computers used to control industrial systems. A PLC may be programmed using a specialized programming language and used to control a variety of different devices and systems, including the gauges 620, valves 622, the boost pump 604, the main pump 714 and the actuators 706. Microcontrollers are small, single-board computers designed for dedicated control tasks in embedded systems. Microcontrollers integrate a processor, memory, and input/output peripherals on a single board and are commonly used to control, send information to and receive information from devices such as sensors, actuators, and displays. The microcontrollers may be programmed using a variety of different programming languages, such as, for example, C or C++, and are optimized for real time operation. Computer-based controllers are based on general purpose computing platforms such as industrial PCs, offering greater processing power, memory, and flexibility to enable them to run complex software and manage larger scale control systems. Computer-based controllers may interface with a wide range of devices and systems, including gauges, sensors, valves and networked equipment. Computer-based controllers can be programmed using a variety of different programming languages such as, for example, Python, Java, or specialized control languages.

The cryogenic tandem pump system 600 may include one or more valves. The primary function of the valves is to isolate the system from external connections, particularly during periods of non-operation or for maintenance purposes. For example, a valve may be placed on an inlet pipe leading to the reservoir 602 (not shown) and another placed at a connection point after the main pump 614. When these valves are closed, the system 600 is fully isolated such that no cryogenic fluid enters or exits the system. In accordance with standard cryogenic practice, any isolated section of the system should be purged to avoid retaining cryogenic liquid in a closed volume. The valves may be of ball, globe, gate, or other types suitable for cryogenic service. The valves may be manually operated by an operator or electrically actuated by controller 624.

Each of the gauges 620, the boost pump 604, the main pump 614 and the actuators 606a/606b are coupled to the controller 624 for communication and to permit the controller 624 to regulate their respective functionality for manipulating flow of cryogenic liquid within the system 600. The components may be configured to communicate with the controller 624 through a wired connection, such as dedicated signal lines, serial links, or a network-based connection, or through a wireless connection, such as radio-frequency, infrared, or other wireless communication techniques. For example, the components may communicate with the controller 624 through a wired or wireless network, including, for example, ethernet, fieldbus, controller area network (CAN), or a wireless mesh network. One or more of the components may include integrated circuitry, modules, or transceivers configured to enable wireless communication with the controller 624. To use the controller 624 to control the gauges 620, the boost pump 604, the main pump 614 and the actuators 606a/606b, the controller 624 is programed to perform necessary control functions. This may involve including software code or creating a control program that specifies the specific control functions that the controller should perform. Once the controller 624 has been programmed, it can be used to control the operation of the gauges as desired to achieve the functionality of the cryogenic tandem pump system 600.

The primary function of the controller 624 is to dynamically control the boost pump 604 and the main pump 614 such that the system 600 produces zero tank return (to avoid tank pressure build up). The controller 624 accomplishes this by monitoring the NPSHr and NPSHa flowing in the system 600 through the gauges 620 and dynamically controls either the boost pump 604 or the main pump 614 to feed the appropriate amount of cryogenic liquid into the system needed to meet the NPSHr for either of the given pumps. As the boost pump 604 supplies the main pump 614 with cryogenic liquid, the controller 624 monitors the NPSHa. The controller 624 dynamically controls the speed, acceleration and stroke of the boost pump 604 so as to provide the NPSHr for the main pump 614 without exceeding NPSHr that would then require a blow off valve or return line. The controller 624 continuously takes measurements from the gauges 620 and calculates the flow rate needed for the main pump 614 and simultaneously controls the boost pump 604 output or to obtain the desired pressure in the system 600. The controller 624 not only regulates the boost pump 604 in this manner but can also regulate the main pump 614 to suction the exact amount of cryogenic liquid that is provided by the booster pump 604 to eliminate the need for tank return.

The controller 624 dynamically controls the boost pump 604 and the main pump 614 directly or controls the actuators 606 such that the motion profile of either pump is altered. The controller 624 can dynamically control the speed of the pumps or actuators by adjusting the power supplied using a PLC or microcontroller. The controller 624 itself may command the PLC or microcontroller to make the necessary changes or the PLC or microcontroller may be pre-programmed to monitor the gauges 620 to alter the power supply. Depending on the type of actuator 606 used, for example whether a DC actuator, an AC induction actuator, a brushless DC actuator, pneumatic actuator or hydraulic actuator, the method of control varies. For DC actuators, speed is typically controlled by adjusting the voltage using pulse-width modulation, where the microcontroller rapidly switches the actuator's power on and off to vary the effective voltage. For AC actuators, speed is controlled by changing the frequency of the AC power using a variable frequency drive, which can also be directed by a microcontroller. For brushless DC actuators, an electronic speed controller adjusts power delivery based on pulse-width modulation or digital signals from the controller or microcontroller. The method of controlling the actuator continually varies depending on the type of actuator 606 utilizes.

By dynamically matching the output characteristics of the boost pump 604 to the operational requirements of the main pump 614, overflow waste from excess boost pump 604 flow may be reduced or eliminated, while cavitation resulting from insufficient boost pump 604 flow may also be reduced or eliminated. The system may be configured to automatically compensate for variations in fluid conditions and progressive wear on either pump by adjusting operating parameters in response to measurable changes at the inlets and outlets as detected via the gauges 620. Certain issues may be mitigated by selectively adjusting one or more parameters of the pumps operation including position, velocity and acceleration as a function of time. These issues include but are not limited to changes in inlet or outlet pressures, changes in inlet our outlet temperatures, wear on piston rings, damage to pistons or cylinders, damage to check valves or other leakages in the system.

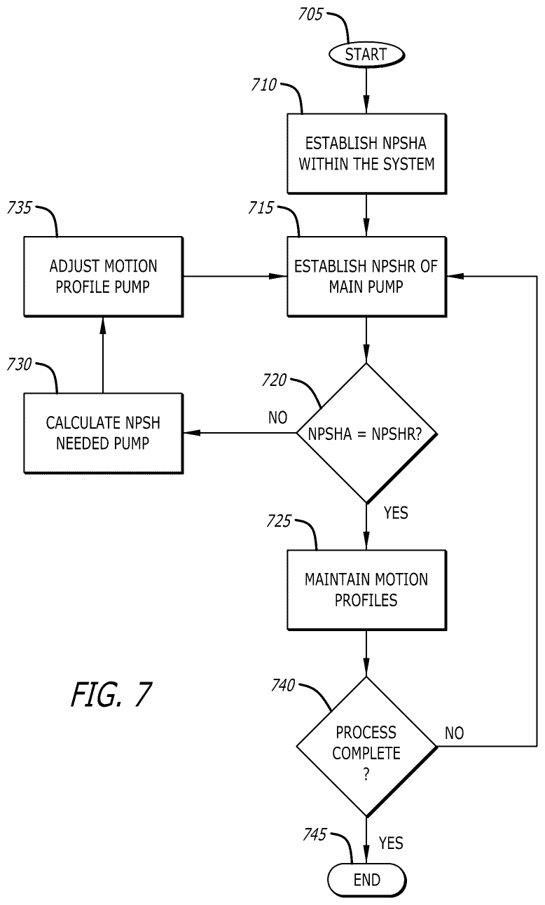

FIG. 7 is a flow diagram for a method for controlling the NPSHa within a cryogenic tandem pump system. The flowchart begins at 705 and ends at 745 but may continue indefinitely as the process is taking place. The process discussed herein refers to the controller's ability to monitor and adjust the boost pump during the pumping of cryogenic liquid from a reservoir as described above with the cryogenic tandem pump system shown in and described above regarding FIGS. 1-7.

Following the start at 705, the process begins with engagement with the cryogenic tandem pump system. Engagement here means powering the system and booting the controller of the system to begin pumping of the cryogenic liquid stored in the reservoir. Following commencement of the system, the controller receives from the gauges readings of NPSHa of the system at 710. The controller then establishes the NPSHr of the main pump at 715. A determination is made whether the NPSHa within the system is equivalent to the NPSHr of the main pump at 720.

If the NPSHa is equivalent to the NPSHr of the main pump (“yes” at 720), the process continues at 725, wherein the controller maintains the motion profiles of the boost pump and the main pump.

If the NPSHa is no equivalent to the NPSHr (“no” at 715), the process continues to 730 wherein the controller calculates the NPSH needed for the main pump. The process then continues to step 735 wherein the controller adjusts the motion profile of the boost pump to produce the NPSHa. The process then returns to step 715 to establish the NPSHa, and repeats the determination evaluation 720 to determine of the change in motion profile was sufficient to equate the NPSHa with the NPSHr.

At 740, a determination is made whether the pumping process is complete. The determination that the process is complete may be user initiated such that the user uses the controller to stop the system if certain criteria are met. For example, if the available cryogenic liquid level in the reservoir is insufficient to supply the appropriate NPSHr for the main pump, and no adjustments to the boost pump can be made to make up this deficiency, the controller may power down the system. If the process is not complete (“no” at 740) the process returns to step 715.

When the process is complete (“yes” at 740), the process then ends at 795.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A cryogenic tandem pump system comprising:
a cryogenic reservoir for storing cryogenic liquid;
a first pump engaged with a first actuator and connected to a first sump, the first actuator connected to a first microcontroller;
a second pump engaged with a second actuator and connected to a second sump, the first actuator connected to a first microcontroller, the second pump being asynchronous with the first pump;
a pump controller configured to dynamically control displacement, velocity and acceleration of the first and second pumps; and
at least one gauge for monitoring the flow and pressure of the cryogenic liquid within the system;
wherein the cryogenic reservoir, the first pump and the second pump are fluidly connected via piping, the first pump in series with the second pump, the first pump located upstream from the second pump to serve as a booster to the second pump, the second pump configured at a higher pressure than the first pump, and the pump controller to regulate the flow of cryogenic liquid between the first and second pumps to produce zero return.

2. The cryogenic tandem pump system of claim 1, wherein the pump controller is configured to monitor the NPSHr of the second pump.

3. The cryogenic tandem pump system of claim 2, wherein the pump controller is configured to dynamically adjust at least one of the displacement, velocity and/or acceleration of the first pump to deliver sufficient cryogenic liquid to satisfy the second pump's NPSHr.

4. The cryogenic tandem pump system of claim 1, wherein the pump controller is configured to monitor the NPSHa generated by the first pump.

5. The cryogenic tandem pump system of claim 4, wherein the pump controller is configured to dynamically adjust at least one of the displacement, velocity and/or acceleration of the second pump to receive sufficient cryogenic liquid based on a NPSHa generated by the first pump.

6. The cryogenic tandem pump system of claim 1, wherein the first pump and the second pump are configured with a single sump.

7. The cryogenic tandem pump system of claim 1, wherein the first pump is single or double acting.

8. The cryogenic tandem pump system of claim 1, wherein the first pump is submerged, semi-submerged or externally placed from the cryogenic reservoir.

9. The cryogenic tandem pump system of claim 1, wherein the first actuator type is selected from the group including hydraulic, electric, or pneumatic.

10. The cryogenic tandem pump system of claim 1, wherein the second pump is single or double acting.

11. The cryogenic tandem pump system of claim 1, wherein the second pump is submerged, semi-submerged or externally placed from the cryogenic reservoir.

12. The cryogenic tandem pump system of claim 1, wherein the second actuator type is selected from the group including hydraulic, electric, or pneumatic.

13. A cryogenic tandem pump system comprising:
a reservoir housing cryogenic liquid;
two fluidly connected asynchronous pumps in series driven by separate actuators each configured with a microcontroller, each of the two asynchronous pumps connected to separate sumps;
a pump controller configured to dynamically control at least one of the displacement, velocity and/or acceleration of the two asynchronous pumps; and
at least one gauge for monitoring the flow and pressure of the cryogenic liquid within the system;
wherein the reservoir is fluidly connected with the two asynchronous pumps, the first pump of the two asynchronous pumps serves as a booster to the second asynchronous pump, the second asynchronous pump operates at higher pressure than the first asynchronous pump, and the pump controller is configured to regulate the flow of cryogenic liquids between the two asynchronous pumps to produce zero return.

14. The cryogenic tandem pump system of claim 13, wherein the pump controller dynamically adjusts at least one of the displacement, velocity and/or acceleration of the first pump of the two asynchronous pumps to deliver sufficient cryogenic liquid at a NPSHr of the second pump of the two asynchronous pumps.

15. The cryogenic tandem pump system of claim 13, wherein the pump controller is configured to dynamically adjust at least one of the displacement, velocity and/or acceleration of the second pump of the two asynchronous pumps to receive sufficient cryogenic liquid based on a NPSHa generated by the first pump.

16. The cryogenic tandem pump system of claim 13, wherein the two asynchronous pumps are configured with a single sump.

17. The cryogenic tandem pump system of claim 13, wherein the two asynchronous pumps are single or double acting.

18. The cryogenic tandem pump system of claim 13, wherein the two asynchronous pumps are submerged or externally placed from the cryogenic reservoir.

19. The cryogenic tandem pump system of claim 13, wherein the actuator type configured with the two asynchronous pumps is selected from the group including hydraulic, electric, or pneumatic.

20. A method for delivering cryogenic liquid using an asynchronous tandem pump system producing zero return, the method comprising:
receiving from a tank reservoir cryogenic liquid at a first pump engaging with a first actuator and connected to a first sump, the first actuator connected to a first microcontroller;
feeding the cryogenic liquid at a first flow rate from the first pump to a second pump, the second pump engaging with a second actuator and connected to a second sump, the second actuator connected to a second microcontroller;
outputting the cryogenic liquid from the second pump at a second flow rate;
monitoring the NPSHr and NPSHa of the first and second pumps;
dynamically controlling at least one of the displacement, velocity and/or acceleration of the first and second pumps to control the first flow rate and second flow rate of the cryogenic liquid at a desired NPSHr.
